(19) United States
(12) Patent Application Publication
(10) Pub. No.: US 2025/0307806 A1
(43) Pub. Date: Oct. 2, 2025

(54) Content Distribution and Management Systems and Methods

(71) Applicant: Intertrust Technologies Corporation, Berkeley, CA (US)

(72) Inventors: Talal Shamoon, Berkeley, CA (US); Albhy Galuten, Santa Monica, CA (US); Guido Cugi, Cupertino, CA (US)

(73) Assignee: Intertrust Technologies Corporation, Berkeley, CA (US)

(21) Appl. No.: 19/092,917

(22) Filed: Mar. 27, 2025

Related U.S. Application Data
(60) Provisional application No. 63/572,861, filed on Apr. 1, 2024.

(51) Int. Cl. G06Q 20/38; G06F 21/10; G06Q 20/12

(52) U.S. Cl. CPC G06Q 20/3829; G06F 21/107; G06Q 20/123; G06Q 2220/18

(57) ABSTRACT

Embodiments of the disclosed systems and methods provide for the management of the distribution and licensing of content using various content distribution and management techniques. Content links consistent with the disclosed embodiments may be used in connection with the disclosed systems and/or services to provide an integrated framework through which artists and/or creators may manage their content assets and/or facilitate the distribution and use of such content assets in accordance with agreements associated with the assets. Artists and/or creators may distribute content links via a variety of channels in connection with promoting their content. Content consumers may interact with such content links to interface with rights license services, which may in turn access agreements identified by and/or accessible using information included in the content link information in connection with license generation and issuance and agreement enforcement.

### REFERENCE TO RELATED APPLICATIONS

This application claims the benefit of priority under 35 U.S.C. § 119 (e) to U.S. Provisional Application No. 63/572,861 filed Apr. 1, 2024, and entitled “Content Distribution and Management Systems and Methods,” which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY OF THE INVENTION

The present disclosure relates generally to systems and methods for managing and distributing content. More specifically, the present disclosure relates to systems and methods for managing the distribution of content, which may recognize fractional ownership and/or other interest rights, in a content marketplace using content link information.

Many conventional content distribution paradigms, including music distribution channels, are generally centralized in nature. For example, the world of content and/or media distribution and governance has steadily come under the control of a few powerful aggregators. This centralized nature may result result in less control by artists and other content creators as well as by consumers who ultimately enjoy their content.

Embodiments of the disclosed systems and methods enable artists, creators, and/or content rightsholders (which may in certain instances be generally referred to interchangeably herein, but may not necessarily all be the same entities) to connect with consumers of their content, while reducing the overhead of that connection, reducing and/or removing the leverage of the gatekeepers. In some embodiments, a governed architecture is detailed that can be utilized by creators and consumers with relatively low overhead. Content and access to content may be governed by the agreements between the creators and associated consumers, which in some embodiments may be implemented in a distributed and immutable fashion.

Embodiments of the disclosed systems and methods provide for content distribution and management architectures and associated methods that are more decentralized in nature, allowing for greater control and management by artists, creators, and consumers. This may allow, for example, a consumer to purchase a song or album by an artist and listen to it on multiple devices and an artist to curate a user experience in sharing albums and associated content, tour dates, lyrics, credits, and/or the like, which may be dynamically controlled and/or otherwise managed by the artist.

In various embodiments, artists and consumers may interact with a content distribution service in connection with content distribution, management, and engagement related services. The content distribution service may interface with payment gateway services and/or marketplace services to facilitate, among other things, payment from consumers and/or other parties to artists, creators, and/or rightsholders, interactions with a content distribution network and/or packaging services, management of rights to content using digital rights management (“DRM”) services and/or blockchain services, which may associate content with tokens (e.g., non-fungible tokens (“NFTs”)) that may be managed using trusted ledgers (e.g., blockchains).

Embodiments of the disclosed systems and methods may provide elements of an ecosystem for registering and uploading of content, downloading of content (and/or other products which may be represented by digital tokens), creation and/or packaging of digital assets and/or products, listing of content and/or products, delisting of digital assets and/or products, updating of digital assets and/or products, sharing of digital assets and/or products, playback of digital assets and/or products, and/or the like. Further embodiments may facilitate compensation of a rights holder and/or plurality of rights holders associated with content, product, and/or associated NFT(s) based on consumer usage and/or interaction with associated content, products, and/or NFTs. Certain embodiments may use one or more commercial blockchain ledgers such as, for example and without limitation, the FLOW blockchain, and blockchain connector services to provide mechanisms to readily implement aspects of the disclosed systems and methods with such established blockchain architectures.

As used herein, creatives, creators, artists, and/or the like (which, again, in certain instances may be used interchangeably herein) may be used to describe songwriters and composers, performers, journalists, videographers, photographers, graphic artists, writers, architects, designers of 3-dimensional objects and any other person or group of people and/or machines (e.g., generative artificial intelligence engines) that create content. Content, media, creative works, and/or the like (which may be generally referred to herein in certain instances for purposes of simplicity simply as content) may be used herein to refer to works made by artists. Embodiments disclosed herein provide tools for artists to distribute their content freely while still controlling their own business use cases and being remunerated directly by their consumers. This may, in some implementations, create closer links between the creator and the consumer.

Content links, as detailed in connection the disclosed embodiments, can be utilized within the disclosed systems and services to create a unified framework that enables artists and creators to manage their content assets and oversee their distribution and usage in accordance with associated agreements. Artists and creators can share these content links through various channels to promote their work. Content consumers can engage with these links to connect with rights license services, which use the information embedded in the links to identify and access relevant agreements for generating and issuing licenses, as well as enforcing the terms of those agreements.

### BRIEF DESCRIPTION OF DRAWINGS

The inventive body of work will be readily understood by referring to the following detailed description in conjunction with the accompanying drawings, in which:

FIG. 1 illustrates a non-limiting example of a content distribution and management architecture consistent with certain embodiments disclosed herein.

FIG. 2 illustrates a non-limiting example of a conceptual diagram showing a content distribution and management architecture consistent with certain embodiments disclosed herein.

FIG. 3 illustrates a non-limiting example of a relationship between an artist and various other entities and services consistent with certain embodiments disclosed herein.

FIG. 4 illustrates a conceptual diagram of a non-limiting example of a process associated with issuing rights licenses consistent with certain embodiments disclosed herein.

FIG. 5 illustrates a non-limiting example of tools used in marketing, promotion, and superdistribution processes consistent with certain embodiments disclosed herein.

FIG. 6 illustrates a non-limiting example of an asset creation process consistent with certain embodiments disclosed herein.

FIG. 7 illustrates a non-limiting example of an asset purchase process consistent with certain embodiments disclosed herein.

FIG. 8 illustrates a non-limiting example of an asset playback process consistent with certain embodiments disclosed herein.

FIG. 9 illustrates a non-limiting example showing content link information associated with content and various interactions with content distribution ecosystem services consistent with certain embodiments disclosed herein.

FIG. 10 illustrates a flow chart of a non-limiting example of content management processes consistent with certain embodiments disclosed herein.

FIG. 11 illustrates a non-limiting example of a system that may be used to implement certain embodiments of the systems and methods of the present disclosure.

### DETAILED DESCRIPTION OF THE INVENTION

A description of systems and methods consistent with embodiments of the present disclosure is provided herein. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to certain drawings included herein, wherein like parts may, in certain instances (but not necessarily all), be designated with like numerals. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. Given examples are to be understood as illustrative and non-limiting, whether indicated explicitly as such or not. In addition, the steps of any method disclosed herein do not necessarily need to be executed in any specific order, or even sequentially, nor need the steps be executed only once, unless otherwise specified.

Moreover, it will be understood that, as used herein, a process and/or method step that is described as being “based on” some information is not necessarily exclusively based on that information, but indeed may be based at least in part on the information and/or a portion thereof and/or other information, even if not explicitly indicated as so. Additionally, it will be understood that the terms “entity,” “system,” and/or “service” may, in certain but not necessarily all, instances herein be used interchangeably.

It will be also appreciated that all examples described herein are intended to be illustrative of applications of various embodiments of the disclosed systems and methods to facilitate an understanding of the embodiments, and are not intended to be limiting examples, even if not specifically identified as such. For example, although various implementations are described the context of music distribution, it will be appreciated that the disclosed embodiments may be used in a variety of other contexts including, for example and without limitation, in connection with movie distribution, television production, book publishing, and/or any other suitable type of content production, distribution, and/or management context.

Embodiments of the disclosed systems and methods may provide for dynamic management of content in a secure way, where the rights of rights holders in such content are respected and/or otherwise enforced. Various embodiments disclosed herein may use trusted ledgers to securely record certain assertions relating to the content, rightsholders, and/or various ecosystems participants. Such assertions may be used in connection with rights binding, content packaging, management, and/or protection operations in connection with a variety of transactions associated with content, products, and/or associated NFTs.

In various embodiments, consumers can access content through a content distribution service (e.g., via a portal and/or an application). The availability of content for streaming and/or downloading by the service may be determined based on content rightsholder preferences (e.g., rules set by artists). Consistent with embodiments disclosed herein, in some implementations, consumers may have the capability of redistributing content, which in certain instances herein may be referred to as content superdistribution. This may allow a media file to be shared among multiple parties, which may need to acquire an associated DRM license to access the content.

Content links may provide a framework for the management and sharing of content assets by artists through a variety of promotional channels in a manner through which control of the use and/or distribution of their content throughout the content lifecycle in accordance with enforcement agreements may be maintained. Content consumers may engage with information included in content links to connect with various services to facilitating content license acquisition, payment services, and content distribution.

In certain embodiments, content rightsholders, creators, and/or artists may have the option to publish their content on social media platforms. Similar to superdistribution models, consumers who discover content on social media platforms may be directed to content distribution services consistent with the disclosed embodiments to obtain DRM licenses which may be required to access, view, and/or otherwise use the content.

Content distribution services consistent with embodiments disclosed herein may support traditional business models by offering consumers the option to purchase content on an à la carte basis and/or through a subscription model. Embodiments disclosed herein also support fractional ownership models, enabling multiple parts to acquire shares in content and allowing them to earn revenue based on the financial performance of the content. Content distribution services may provide users (e.g., artists and/or consumers) with an interface designed to provide an understanding of the trends and/or value of the assets they own and/or otherwise hold rights to. This interface may, in some implementations, facilitate trading of shares in content, enabling users to actively manage their content investments.

In certain implementations, content creators and/or artists, which may be generally referred to herein as artists, and/or rightsholders (which may or may not be creators and/or artists but may be downstream ecosystem participants that have acquired rights to content from original rightsholders) may be provided control of their content. Consumers may be provided control over what they consume via customization of content distribution services and/or associated interfaces. Aspects of the disclosed systems and/or services may facilitate, among other things, interactive experiences between artists and their fans, reward systems and/or collectables (e.g., digital, physical, and/or the like) available through the platform, and/or profiling algorithms which may promote small and larger artists (potentially equally, based on user preferences, and/or based on distribution service promotion goals).

Some embodiments of the disclosed content distribution service may facilitate offering of different tiers of subscription. A consumer may decide to support their favorite artists by subscribing for a fee to their content. In exchange, they may receive certain rewards and/or content such as, for example and without limitation, redeemable credit for purchasing fractional shares to content, exclusive content available via the content distribution service, early access and/or discounted tickets to live events, limited live recordings, behind the scenes clips, and/or the like. Users may also be offered the option to directly purchase credits, which may be used to, among other things, purchase fractional shares of content assets, redeem and/or cash out credit investments, purchase tickets to live events, and/or the like.

It will be appreciated that, as used herein, content may refer to any digital media content and/or associated assets, which may be represented as and/or otherwise be associated with NFTs for purposes of content management and distribution, and may include any type of media content. For example and without limitation, content may comprise, audio content, video content, text content, image content, and/or any combinations of the same. Content may be individually packaged (e.g., in the form of songs), packed in collections (e.g., album based, live-recording based), exclusive in nature (e.g., behind-the-scenes podcasts, early test recordings, and/or the like), and/or the like.

Certain aspects of the disclosed processes may be performed by and/or otherwise be performed in connection with one or more entities, services, and/or systems that may include, for example and without limitation, one or more of:
Content distribution service—A service, which may comprise a front-end service, a back-end service, and a content rights management database, which may be used in connection with managing rights of artists and/or consumers.
Marketplace service—A service, which may comprise a third-party service that uses a trusted data management platform (“TIP”) service (or, in certain instances herein, more generally a “trusted data management service”) for NFT and/or DRM implementations. In some embodiments, the marketplace service may include an abstraction layer allowing for streamlined interfacing with the marketplace service by other services, an Upload and Packaging Service (“UaPS”), an orchestrator service, which may allow the marketplace service to interact with and/or otherwise call other services (e.g., DRM services and/or blockchain connector service).
Rights license and/or DRM service—A service offering DRM and/or authenticated licensing related services.
Blockchain connector service—A service facilitating interactions between services and a blockchain and/or blockchain service.
Blockchain—A blockchain service and/or other suitable trusted ledger service that may be provided by the marketplace service and/or another service and/or entity. Although various examples described herein may use a trusted immutable distributed assertion ledger (“TIDAL”), it will be appreciated that various embodiments and aspects of the disclosed systems and methods may be implemented using a variety of other trusted databases, ledgers, and/or blockchains that may, or may not, have certain attributes associated with a trusted distributed assertion ledger. For purposes of simplicity and explanation, in certain instances, the term trusted ledger may be used herein to generally refer to trusted and/otherwise secure ledgers, which may in some (but not necessarily all) implementations comprise attributes of blockchain and/or TIDAL ledgers.
Packager service—A service which may be used to package content, potentially based on interactions with the DRM service.
A content distribution network (“CDN”)—A service facilitating the distribution and/or transmission of packaged content (e.g., catalog content and/or streaming media).
Social media service(s)—Any suitable service and/or platform offering social media services to artists and/or consumers.
Payment gateway—A service facilitating payment between various services and entities in connection with certain transactions involving content.

### Content Distribution Service Ecosystem

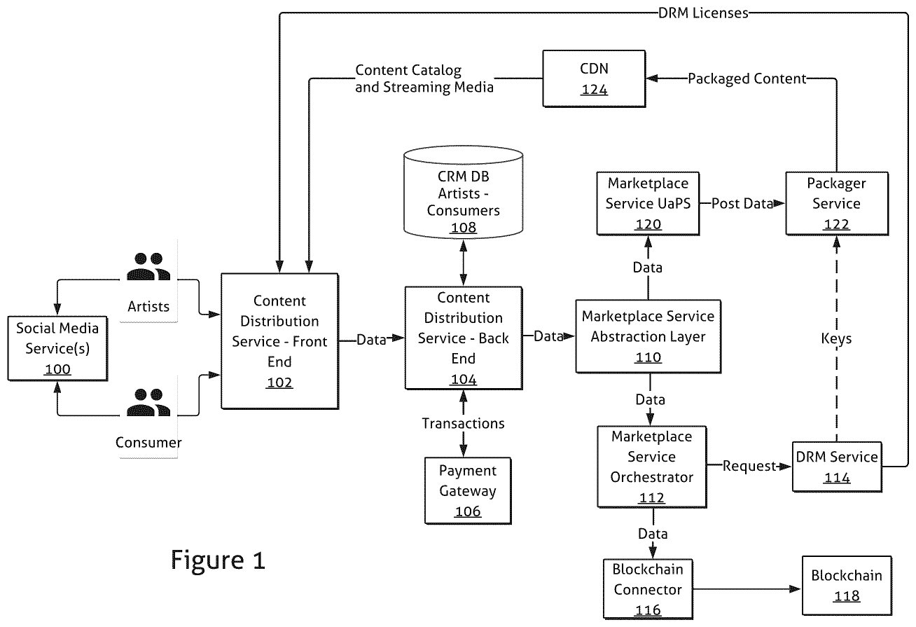

FIG. 1 illustrates a non-limiting example of a content distribution and management architecture consistent with certain embodiments disclosed herein. Although certain connections and/or interactions between the various services, layers, and/or entities may be illustrated in FIG. 1 and the other figures herein as being directional, it will be appreciated that this is simply for purposes of illustration and explanation and that interactions between the various services, layers, and/or entities may be bi-directional and/or be different than that specifically illustrated or implied by any directionality shown in the figures.

As shown, artists (which may also be referred to herein as content creator(s)) and consumers may interact with social media platforms and/or services 100. Using these services 100, artists can publish news and promote their work(s), consumers can discover and interact with new artists (e.g., directly, organically, and/or via recommendation services) and/or with established favorites. A variety of other platforms and/or services may be used by artists and/or consumers to interact with each other in connection with the disclosed embodiments.

Consistent with embodiments disclosed herein, artists and/or consumers may interact with a front-end service 102 of a content distribution service in connection with various content operations and/or actions. The front-end service 102 may, among other things, provide an interface for artists and/or consumers to browse content managed by the content distribution service, access content in accordance with content links, receive content downloads and/or streams, receive licenses and/or interact with licenses services (e.g., DRM service 114) and/or the like.

The content distribution service front-end service 102 may interface with and/or otherwise share data with a content distribution service back-end service 104. The back-end service 104 may interact with a payment gateway 106 in connection with facilitating various transactions. For example, interactions with the payment gateway 106 (and/or other payment services) may facilitate the purchasing of content, the rental of content, and/or the like.

The content distribution service back-end service 104 may interface with a content rights management (“CRM”) database 108. The CRM database 108 may store certain associations articulating rights to content associated with artists, rightsholders, and/or consumers. For example and without limitation, the CRM database 108 may include entries indicating which artist(s) and/or rightsholder(s) hold rights to content, the type and/or nature of such rights, availability of content for distribution, sale, rental, etc., and/or the scope of rights associated with the same, rights associated with particular content consumers and/or groups of content consumers, which may be expressed specifically relative to a piece of content (e.g., User A has access to Content B) or generally (e.g., User A has access to a certain category of content, content associated with a certain rightsholder, artist, studio, etc.) and/or the like.

The back-end service 104 of the content distribution service may interact with an abstraction layer 110 of a marketplace service to invoke various services of the marketplace service. For example, the service abstraction layer 110 may allow the back-end service 108 to interact with a marketplace service orchestrator 112, facilitating interactions with a DRM service 114 (e.g., DRM license requests) and/or a blockchain connector service 116, which may allow the marketplace service to interact with one or more blockchain services 118 in connection with recording and/or verifying assertions consistent with various aspects of the disclosed embodiments. The service abstraction layer 110 may further interact with a marketplace service upload and packaging service (“UaPS”) 122 which may post data with a content packager service 122.

The content packager service 122 may package content for distribution via a content distribution network (“CDN”) 124. The CDN 124 may share the content catalog and/or available streaming media with users and/or artists via the content distribution service front-end service 102. In some embodiments, keys may be received by the packager service 112 from the DRM service 114 for use in connection with content packaging operations. The DRM service 114 may further provide DRM license(s) as appropriate to the content distribution service front-end service 102 as part of the content distribution process.

### Content Link Information Overview

Consistent with embodiments disclosed herein, and as discussed in more detail below, content links may be used in connection with the disclosed systems and/or services to provide an integrated framework through which artists and/or creators may manage their content assets and/or facilitate the distribution and use of such content assets in accordance with agreements associated with the assets. Artists and/or creators may distribute content links via a variety of channels in connection with promoting their content. Content consumers may interact with such content links to interface with rights license services, which may in turn access agreements identified by and/or accessible using information included in the content link information in connection with license generation and issuance and agreement enforcement.

### Content Distribution and Management Architecture Example Processes

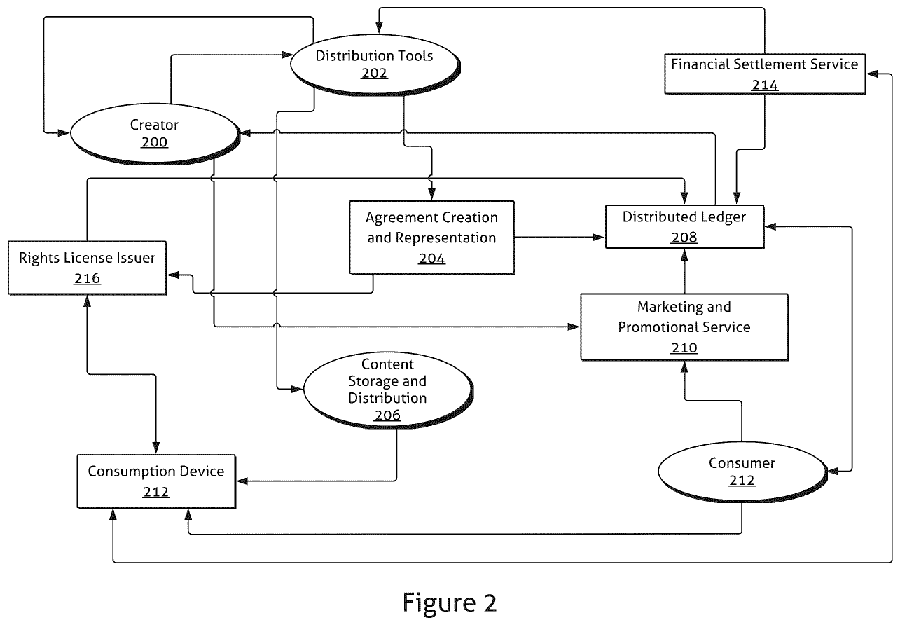

FIG. 2 illustrates a non-limiting example of a conceptual diagram showing a content distribution and management architecture consistent with certain embodiments disclosed herein. As illustrated, a creator 200, which as noted above may also be referred to herein as an artist, who has a creative work may use a set of distribution tools 202 to encode, engage in rights agreement creation and representation activities 204, which may involve defining the disposition of content, binding the content with associated identities and/or identifiers and/or other information, creation of links to the content and/or associated creator and/or rights holder identities, distribution of the content to media storage 206, and/or write locations, identities, and/or other information included herein to a distributed ledger 208 (e.g., a trusted distributed assertion ledger and/or the like), which in certain embodiments may comprise a blockchain ledger.

The creator 200 may retrieve the content link information associating the content and any associated agreements from the distributed ledger 208 and may publish and/or otherwise post the content link information to a marketing and/or promotional service 210. The marketing and/or promotional service 210 may comprise, for example and without limitation, a social network, a website, an email and/or other electronic marketing service, and/or the like. When a consumer 212 sees and/or follows the promotional link (e.g., using a consumption device 212 associated with the user), the content link information may direct them to the distributed ledger 208. Using the consumption device 212 (and/or another device and/or system), the consumer may engage in one or more transactions (e.g., payment transactions) with a financial settlement service 214. The consumer may also use information accessed from the distributed ledger 208 (e.g., accessed using the content link) to the media storage service 206 where they may access (e.g., via downloading or streaming) the content to their consumption device 212.

Consistent with embodiments disclosed herein, rights to access and/or otherwise use content may be managed via distribution of associated licenses. The consumption device 212 may contact a rights license service 216, which may comprise and/or otherwise be implemented by a DRM service. In some embodiments, the rights license service 216 may query the distributed ledger 208 to determine rights associated with a requesting consumer and/or consumption device 212 and, if rights to access the content are confirmed by the ledger 208, the rights license service 216 may issue a DRM license to the consumption device 212, which may use the license to access the content (e.g., render the content via an interface of the consumption device 212). The financial settlement service 214 may distribute remuneration for the consumption of the content by the consumer to the creator 200 and/or to an entity and/or service implementing the various disclosed distribution tools 202. In various embodiments, the remuneration may be distributed in accordance with various agreements established and securely associated with the content consistent the disclosed systems and methods.

### Creator and Distribution Tools

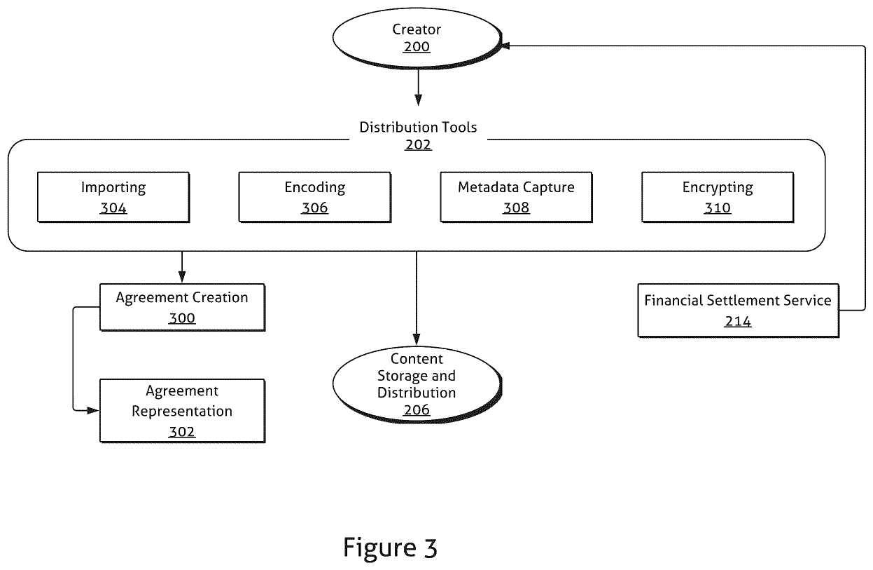

FIG. 3 illustrates a non-limiting example of a relationship between a creator 200 and various other entities and services consistent with certain embodiments disclosed herein. As shown, the creator 200 may use a set of distribution tools 202. These distribution tools 202 can be provided as a service online, a locally run software implementation, and/or a combination of the same.

The creator 200 may have created and/or otherwise have rights to a digital representation of a creative work (e.g., content). Content could comprise, for example and without limitation, a movie, a recording, a composition, a photograph, a journal article, a book, a 3D object, a scene represented by a point cloud, or any other form of media in digital form. It will be appreciated that although certain non-limiting examples presented herein refer to an artist and/or other creator 200 that may be an original creator of content, rights holding parties that may not necessarily be original rightsholders and/or creators may also be used in various embodiments of the disclosed systems, methods, and/or services in connection with the distribution of content.

Various distribution tools 202 included herein may be used to digitize and/or otherwise prepare content for distribution. In certain embodiments, content may be pre-encoded before being provided to the distribution tools 202 for further processing. For example, pre-encoded content may be imported using importing services 304 of the distribution tools 202. In a further example, content may be encoded using encoding services 306 included in the distribution tools 202 available to the creator 200. Encoding services 306 may also include, for example and without limitation content formatting, format conversion, and/or compression services, watermarking services (e.g., embedding of steganographic information in content), and/or the like.

Distribution tools 202 may further include metadata capture services 308. Metadata may be captured in a variety of different ways, but not limited to, filling in a website form, looking up credentials associated with an identifier, facial or fingerprint recognition, analysis of the media using digital signal processing, and/or via any other suitable method. The metadata may include information about the content such as color palate, frame rate, sampling rate, bit depth, compression algorithms, etc., and/or information about the creators and/or associated rightsholders. Once the content has been captured and encoded and the metadata has been captured, the content may be suitably encrypted using encryption services 310 of the distribution tools 202.

Distribution tools 202 consistent with embodiments disclosed herein may further interface with agreement creation 300 and/or representation 302 services. Although illustrated in the figure as being separate from the distribution tools 202, it will be appreciate that these services 300, 302 may be offered as part of the distribution tools 202 that may be used by a creator 200 consistent with various embodiments disclosed herein.

Certain specialized forms of metadata may be used in connection with agreement creation services 300. For example and without limitation, agreement creation services 300 may capture business parameters associated with content such as names of creators and co-creators (e.g., their identities and/or identifying metadata like fingerprints, social security number, etc.), share of ownership and/or rights (e.g. two songwriters each own half of the copyright), representatives of those rightsholders (e.g. music publisher, manager, agency, etc.), licensing terms, restrictions, and/or requirements (e.g. “content can be sold as a non-fungible object like #1 of 20, content can be part of a subscription service, content can be licensed in specific territories, content can be resold, content can be loaned or not for specific time periods or by limited numbers of people, ownership in the royalty stream can be shared fractionally, etc.), which can be as arbitrarily complex as can be represented electronically using any mechanism such as but not limited to DRM techniques.

Agreement representation services 302 may store created agreements for later representation and/or execution. In certain embodiments, agreements may be articulated as a suitable digital representation (e.g. a rights expression, a smart contract, etc.) and that representation may be stored in a database, on an immutable trusted ledger, and/or the like. In certain embodiments, for improved security, a trusted ledger may store a digital signature and a digital hash of the agreement as well as the identities of the signatories. When an agreement is retrieved for execution, the right to retrieve and execute on that agreement can be governed and access granted to those with the correct permissions and credentials.

Once the agreement has been created using agreement creation services 300 and represented using agreement representation services 302 the encoded and or encrypted content can be uploaded to content storage 206. Once the content has been consumed by consumers and the remuneration has flowed to the various parties as prescribed in an associated agreement, a financial settlement service 214 may renumerate the creator 200 (and/or other associated rightsholder) and/or a representative of the same in accordance with any applicable represented agreements.

### Rights License Issuance

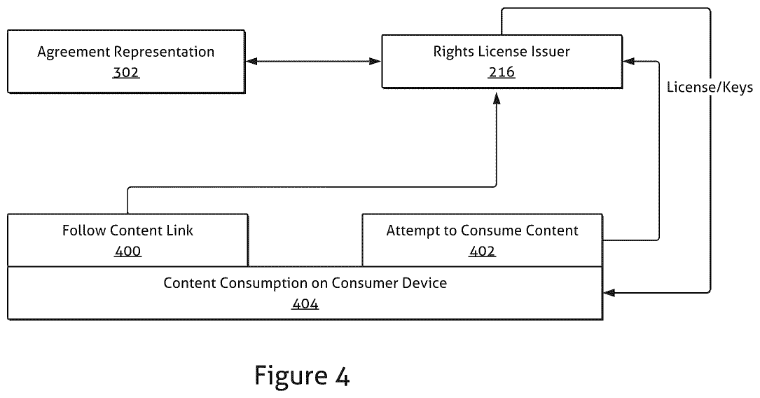

FIG. 4 illustrates a conceptual diagram of a non-limiting example of a process associated with issuing rights licenses consistent with certain embodiments disclosed herein. When a consumer wants to consume content 402, they may select content of interest in a number of ways. For example, a consumer may follow a content link 400 consistent with various disclosed embodiments that may be included in a document, web site, advertisement, etc. The content link may, among other things, reference and/or otherwise provide a link to a rights license issuer 216. In further embodiments, link information may be included in and/or otherwise be associated with already distributed content and, after receiving encrypted content from a third party and attempting to access it via a playback request, the consumer may be directed to the rights license issuer 216 via the content link information to obtain a needed license and/or decryption key to access the encrypted content.

Upon receiving a request from a consumer for a license and/or decryption key, the rights license issuer 216 may look up any agreements associated with the content and/or the consumer (potentially using identification information provided to the rights license issuer 216 from the consumer device as part of the license request) from agreement representation services 302. The agreement representation services 302 may, based on applicable information included in the license request, parse any applicable agreement(s) to determine whether the consumer has the right to consume the content and/or the scope of those rights. Based on indications provided by the agreement representation services 302, the rights license issuer 216 may issue applicable licenses and/or decryption keys to the consumer device, allowing for the consumer device to consume the content 404 as requested.

### Marketing, Promotion, and Superdistribution Tools

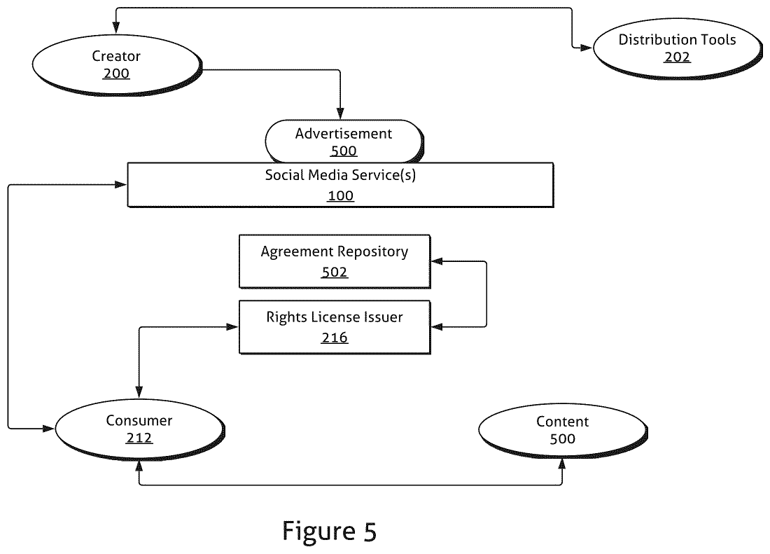

FIG. 5 illustrates a non-limiting example of tools used in marking, promotion, and superdistribution processes consistent with certain embodiments disclosed herein. In certain embodiments, if a creator 200 wants to distribute their content 504, using various aspects of the disclosed services, they may not necessarily need to use a traditional content distribution network like a streaming or download service. They can simply create and distribute the content 504 themselves using various aspects of the distribution tools 202 described herein. They can promote the content 504 through direct advertising with a decentralized set of entities delivering the content 504 and returning any applicable remuneration.

In at least one non-limiting example, after the creator 200 uses the distribution tools 202, they can receive content link information which points back to the content 500, associated agreements (e.g., agreement information included in an agreement repository 502, and/or other relevant information. The creator 200 can published this content link information and/or associated information via a variety of channels. For example and without limitation, the creator 200 can embed the content link information in an advertisement 500 on a web page, in a field in a social media field on a social media service 100, in an email, text, and/or other electronic communication, and/or the like.

When an interested consumer 212 follows the content link information, they may be directed to the rights license issuer 216, which may use information provided by the consumer in connection with following the link (indeed, this information may be included in the content link information itself) to check the agreement repository 502 and determine associated rules, requirements, permissions, and/or privileges, and/or the like associated with accessing the content 500. If the requested access is in accordance with applicable agreement(s) and/or permissions, and/or privileges, the rights license issuer 216 may issue a license to the consumer 212 who may use the license to access the content 500 (e.g., render the content 500 on an associated consumer device). It will be appreciated that the order can vary so that the consumer 212 could select the content 500 first and then acquire the license or these processes could occur in parallel.

In addition to receiving content link information from a web site, social media feed, email, and/or the like, a consumer 212 could receive a link from another consumer. This may be referred to herein as superdistribution. If one consumer sends a content link or the media itself to another entity (e.g., person, device, etc.). the receiving party (e.g., consumer 212) can following on the link information and a similar process to that detailed above may occur.

### Asset Creation, Purchase, and Playback Processes

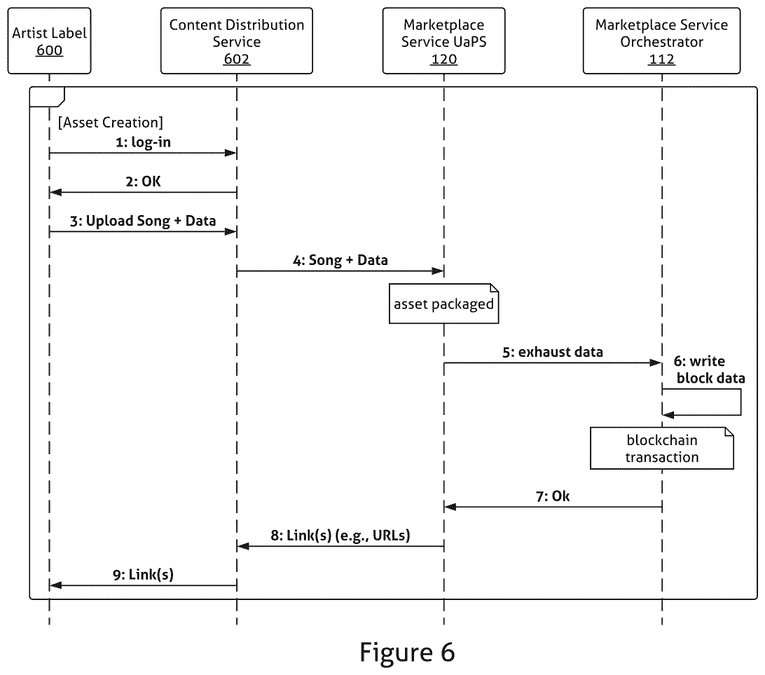

FIG. 6 illustrates a non-limiting example of an asset creation process consistent with certain embodiments disclosed herein. The illustrated process may involve a variety of services and/or entities including, for example and without limitation, an artist label service 600, a content distribution service 602, a marketplace service UaPS 120, and a marketplace service orchestrator 112. Although various examples included herein in reference to FIG. 6 and certain other figures are described in the context of music distribution, where an artist may be a music artist and an artist label 600 may be a music label, it will be appreciated that the disclosed embodiments are not so limiting and indeed may be used in a variety of other contexts and content production, distribution, and/or management paradigms.

As illustrated, as part of an asset creation process, an artist label service 600 (and/or an associated user) may login to a content distribution service 602 using suitable credentials. The content distribution service 602 may authenticate the credentials, returning a response to the artist label service 600. The artist label service 600 may then upload music content and/or associated data (e.g., metadata, agreement information, etc.) to the content distribution service 602, which may communicate the received information and/or a portion thereof to the marketplace service UaPS 120 for packaging.

The marketplace service UaPS 120 may package the received music content and/or associated data into an asset package, which may be provided to the marketplace service orchestrator 112. The marketplace service orchestrator 112 may generate a transaction associated with the generated asset package and record the transaction in a trusted ledger such as, for example and without limitation, a blockchain ledger.

Once recorded in the ledger, the marketplace service orchestrator 112 may confirm the recordation of the asset into the ledger with the marketplace service UaPS 120. The marketplace service UaPS 112 may generate link information associated with the content which, in certain embodiments, may (at least partially) be in the form of one or more URLs. This link information may be shared with the content distribution service 602 and/or the artist label service 600.

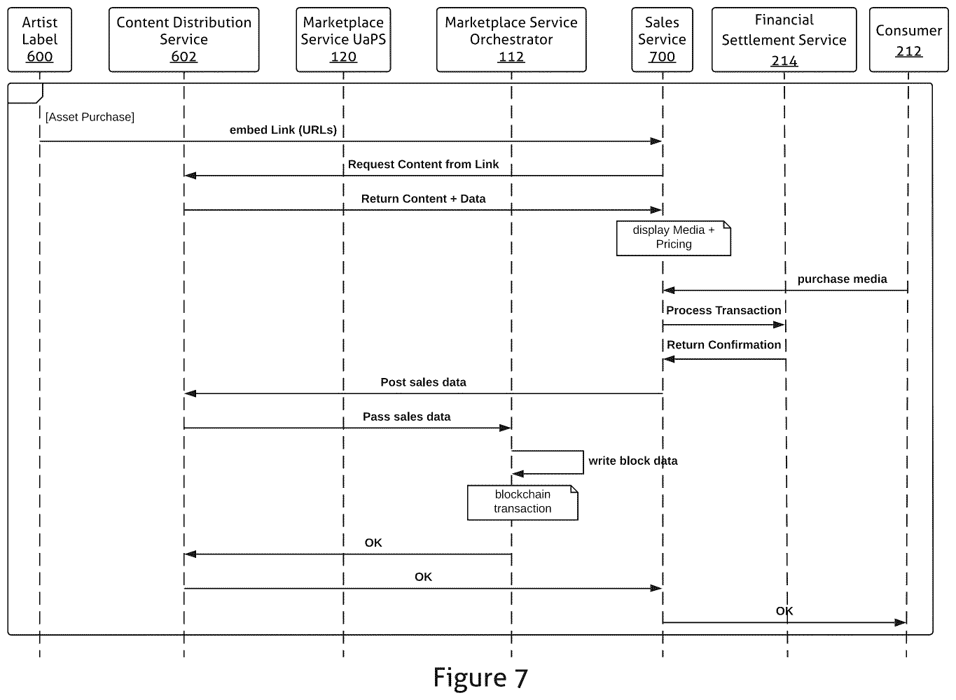

FIG. 7 illustrates a non-limiting example of an asset purchase process consistent with certain embodiments disclosed herein. The illustrated process may involve a variety of services and/or entities including, for example and without limitation, an artist label service 600, a content distribution service 602, a marketplace service UaPS 120, a marketplace service orchestrator 112, content sales service 700 (e.g., a sales website), a financial settlement service 214, and/or a consumer 212 (which is represented in the figure as a consumer device).

An artist label service 600 may embed and/or otherwise include link information to be posted and made available by the content sales service 700. For example, the content sales service 700 may have a sales website which may allow consumers (e.g., consumer 212) to browse and identify various content items available for sale, rental, and/or the like. Although illustrated as a sales service 700, it will be appreciated that similar methods for making content available through posting of content links consistent with aspects of the disclosed embodiments may use social media services, email, text, and/or other marketing services, and/or any other platform or service that may be used to making their content available to potentially interested consumers.

Based on the link information shared by the artist label service 600, the content sales service 700 may request information associated with the content from the content distribution service 602. The content distribution service 602 may return the content and/or associated information (e.g., metadata, pricing information, etc.) to the content sales service 700, which may post the returned information and/or a subset thereof for potentially interested consumers. A consumer 212 may select the content via an interface of the content sales service 700 (e.g., a website and/or the like) and request purchase of the content from the content sales service 700. For example and without limitation, a consumer 212 may request purchase of a perpetual access license, purchase of a limited access license (e.g., a rental license), purchase an access license with certain restrictions (e.g., a conditional license), purchase of a subscription access license, purchase of ownership rights of content and/or fractional shares of the same, and/or the like.

The purchase request may, in certain embodiments, include certain account and/or other payment information that may be used to effectuate one or more financial transactions involve in the purchase of the content. Based on the information included in the purchase request, the content sales service 700 may initiate a transaction with a financial settlement service 214, receiving a confirmation of a successful transaction in return.

The content sales service 700 may post an indication of a successful sale and/or any associated data (e.g., data relating to consumer 212 and/or the like) to the content distribution service 602. The content distribution service 602 may pass this sales information to the marketplace service orchestrator 112. The marketplace service orchestrator 112 may generate a transaction associated with the generated sales information and record the transaction in a trusted ledger such as, for example and without limitation, a blockchain ledger.

Once recorded in the ledger, the marketplace service orchestrator 112 may confirm the recordation of the sales information into the ledger with the content distributions service 602, which may share the confirmation with the content sales service 700. The content sales service 700 may share the confirmation of the purchase transaction with the consumer 212.

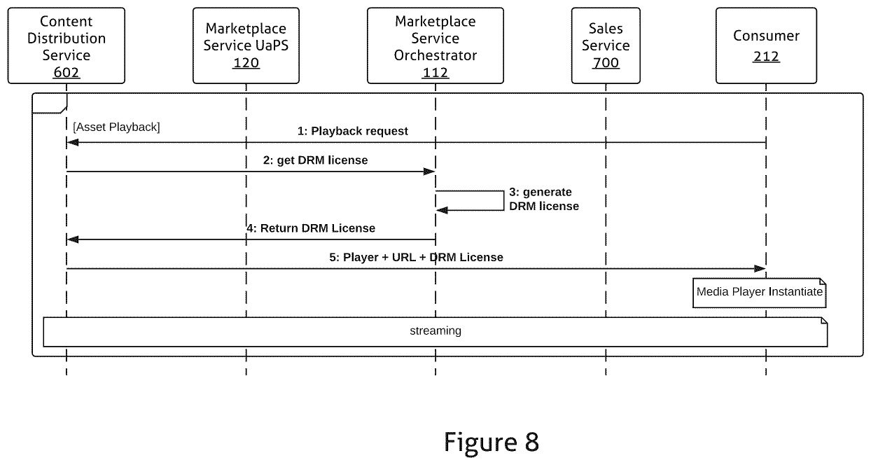

FIG. 8 illustrates a non-limiting example of an asset playback process consistent with certain embodiments disclosed herein. The illustrated process may involve a variety of services and/or entities including, for example and without limitation, a content distribution service 602, a marketplace service UaPS 120, a marketplace service orchestrator 112, content sales service 700 (e.g., a sales website), and/or a consumer 212 (and/or an associated device). Aspects of this illustrated process may be used to facilitate a streaming playback of content, although certain aspects of the disclosed process and various embodiments disclosed herein may also be used in a variety of other content distribution and/or playback contexts.

As shown, a consumer 212 may request playback of purchased content via their device from a content distribution service 602. The content distribution service 602 may request a rights management license from the marketplace service orchestrator 112. The marketplace service orchestrator 112 may generate the requested license and return the license to the content distribution service 602. The content distribution service 602 may communicate the DRM license, applicable link information for accessing the content, and information that may be used to instantiate a streaming player on the device of the consumer 212. Based on the received information, the consumer 212 may instantiate the streaming player and initiate a stream of the content from the content distributions service 602.

### Content Management Using Content Link Information

As detailed herein, content link information consistent with various aspects of the disclosed embodiments may provide a framework through which artists and/or creators may manage their content assets, the distribution and use of such content assets by consumers may be facilitated in accordance with agreements associated with the assets, and remuneration to artists, creators, and rightsholders in accordance with such agreements may be ensured. Content links may be distributed using a variety of channels including, for example, via social media services, emails, text messages, posts and/or advertisements to websites, physical media and content, and/or any other promotional marketing and/or communication channels.

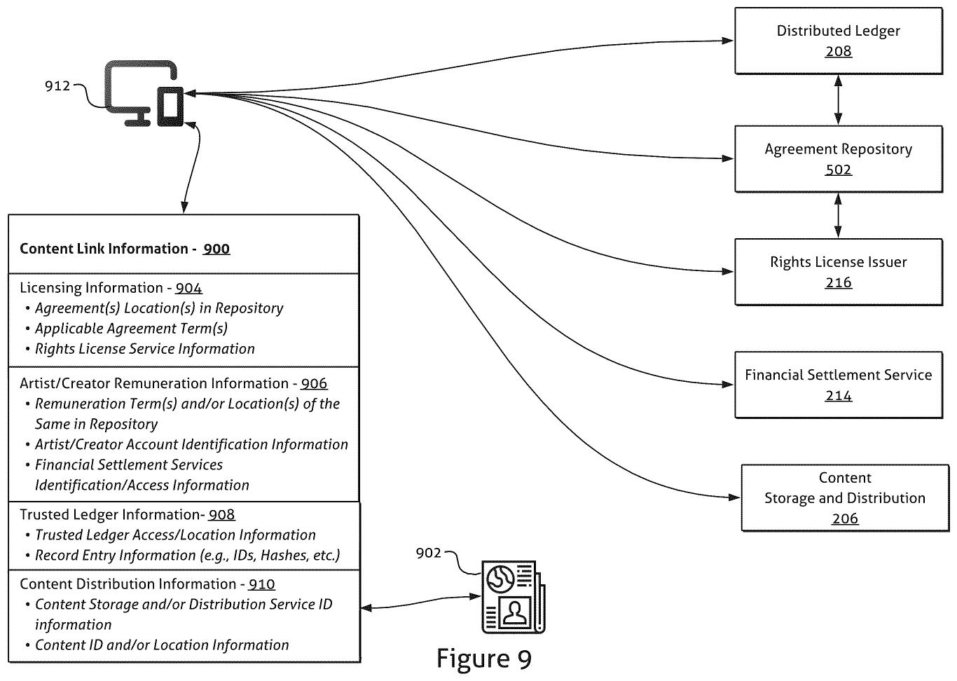

FIG. 9 illustrates a non-limiting example showing content link information 900 associated with content and various interactions with content distribution ecosystem services consistent with certain embodiments disclosed herein. As detailed herein, content consumers may interact with content links 900 to interface with various services in connection with the distribution and consumption of content in accordance with applicable agreements.

Content links 900 may distributed by artists and/or consumers to prospective consumers using a variety of channels. For example, as illustrated, content links 900 may be included in an advertisement 902, which may be printed on a physical medium or be provided to prospective consumers electronically via websites, social media feeds, email communications, and/or the like.

Content links 900 may include a variety of constituent information which may be used in connection with the distribution and consumption lifecycle of content. Although illustrated as separate categories of information in the figure for purposes of explanation and illustration, it will be appreciated that the various types of constituent information included in content links may be organized and/or structured in a variety of other ways. Indeed, content links 900 may comprise some or all of the information illustrated in FIG. 9 and may indeed include in some implementations information not specifically illustrated in the figure.

In certain embodiments, content links 900 may comprise license information 904. The license information 904 may reference locations of any applicable agreement(s) within one or more agreement repositories. The license information 904 may further reference information that may directly link and/or be used to identify agreement information associated with content recorded in a trusted ledger 208. For example and without limitation, in some embodiments, the license information 904 may comprise one or more hashes of applicable agreements and/or content/content identifiers, which may be used to identify corresponding entries recorded in the trusted ledger 208. In further embodiments, license information 904 may include applicable content license terms or a subset thereof and/or an identification and/or access information associated with a rights license service 216 where licenses (e.g., licenses that may include decryption keys for content) may be obtained.

Agreements consistent with embodiments disclosed herein may articulate a variety of information relative to associated content including, for example and without limitation, certain conditional access rights, restrictions, and/or regulations associated with content that may be established by artists, creators, and/or other rightsholders, renumeration associated with the access to and/or use of content, and/or the like. Agreements consistent with embodiments disclosed herein may be structured and/or parsed in a format such that rights management services (e.g., rights license services 216 issuing DRM licenses to consumers) may interpret the rules, restrictions, and/or requirements of such agreements, determine compliance with the rules, restrictions, and/or requirements based on information provided by and/or otherwise associated with consumers, and generate licenses (potentially conditional licenses) based on the same.

Agreements may be securely associated with content via secure cryptographic association techniques. These secure cryptographic associations may, in some embodiments, be implemented using a trusted ledger. In certain embodiments, agreement information may be directly stored in a ledger in a manner that securely associates the agreement information with content and/or identifiers associated with the same. In further embodiments, agreement information may be stored separate from the trusted ledger in an agreement repository, with information associated with the applicable agreement information (e.g., a hash of the information and/or the like) that is securely associated with the content being included in the trusted ledger. The trusted ledger may therefore be used by a service (e.g., a rights license service 214) to validate the association between purported applicable agreements included in a repository with particular content assets.

In certain embodiments, the content link information 900 may comprise artist and/or creator remuneration information 906. The artist and/or creator remuneration information 906 may comprise a variety of information including, for example and without limitation, remuneration terms for artists, creators, and/or rightsholders from users that purchase, access, and/or otherwise use their content, locations of such terms in an agreement repository 502 and/or a trusted ledger 208, identity and/or account information associated with artist(s), creator(s), and/or rightsholder(s), information identifying financial settlement and/or other payment services 214 and providing access information for using such services 214, and/or the like.

Content link information 900 may further comprise trusted ledger information 908. The trusted ledger information 908 may comprise, for example and without limitation, information identifying one or more trusted ledgers 208 and/or information that may be used in connection with accessing the same. Information identifying entries associated with the content item recorded in the ledger may further be included in the content link information 900. In certain embodiments, this information may comprise identification information specifically referencing particular ledger entries. In further embodiments, the information may comprise hash and/or other information that may be used to identify and/or search for relevant recorded entries within the trusted ledger 208.

In yet further embodiments, the content link information 900 may comprise content distribution information 910 that may be used to access the content associated with the link information 900. The content distribution information 910 may comprise, for example and without limitation, information identifying a content storage and/or distribution service 206 that stores the content, content identification and/or location information within the content storage and/or distribution service 206, and/or the like. Using this information, and once any required licenses are obtained and any remuneration requirements are completed, a consumer may, via a consumer device 912, download, stream, and/or otherwise access the requested content items.

Consistent with the disclosed embodiments, using the constituent information included in the content link information 900, a consumer may, via their device 912, interact with the various services involved in accessing, using, and/or otherwise rendering the content item (e.g., the trusted ledger 208, agreement repository 602, rights license service 216, financial settlement service 214, and/or content storage and/or distribution service 206). For example, a consumer may obtain any required licenses to access the content, engage in any required renumeration actions for accessing the content, and/or initiate downloading, streaming, and/or access to the content consistent with applicable licenses. By providing a robust and dynamic framework for the distribution and management of content and associated rights, content links 900 may improve the ability for artists, creators, and/or rightsholders to more directly and/or flexibly manage the distribution of their content when compared to conventional content distribution ecosystems that are more centralized in nature and provide less artist and creator control.

### Content Distribution Service Artist Interfaces

When interacting with a content distribution service consistent with embodiments disclosed herein, a variety of artist and/or creator directed user interfaces may be provided. In certain embodiments, various functional interfaces may be organized and/or otherwise designed based on associated functions, which may include those detailed below.

In some embodiments, an artist may create an account with the content distribution service, logging in via any suitable method (e.g., via single sign on services). Logged in artists can choose to access “Artist/Creator” interface for uploading content and/or a “Personal” interface for purchasing other content.

When accessing the “Artist/Creator” interface, the artist may have access to a content management console (“CMC”). Available interfaces in the CMC may include, for example and without limitation, one or more of the following:
Asset management: An asset management interface may be used in connection with uploading content, uploading and/or updating metadata associate with content, indicating a number and/or price of shares for each content asset, indicating a time period of availability for a content asset, management of public and/or non-public uploaded assets, creation of content links associated with uploaded assets, and/or the like.
Asset tracking: An asset tracking interface may be used in connection with viewing upload status of content assets, viewing streaming and/or other access metrics for public assets, indicating the value and/or increase in shares in an asset over time, playback of content assets (e.g., through a built-in media player), customizable playlist creation for content asset playback, tracking of consumer interactions associated with content assets (e.g., tracking a number of clicks, directs to an asset from other websites and/or services, etc.), and/or the like.
Customizable Personal Profile Management/Editing: A personal profile management and/or editing interface may allow an artist and/or creator to upload certain artist and/or creator information, link accounts with other services (e.g., social media accounts, streaming media and/or other content services accounts, provide links to content assets catalogues which consumers can access for purchasing and streaming of content, and/or the like.

The artist may upload their asset, which may be processed/packaged in the backend of the content distribution service. The artist may then make their uploaded assets available to consumers. A content link may be created per asset, which the artist may share. The artist may optionally create promotional content, which may be posted on online services such as social media and/or other content services and/or be physical content such as physical posters to live events or launch parties, tickets through ticketing services, advertisements, etc. The content link may be posted onto and/or in conjunction with their promotional content (e.g., via a URL website link, QR code, interactive ad, etc.

### Content Distribution Service Consumer Interfaces

When interacting with a content distribution service consistent with embodiments disclosed herein, a variety of consumer directed user interfaces may be provided. In certain embodiments, various functional interfaces may be organized and/or otherwise designed based on associated functions.

A consumer may see a promotional video online through social media outlets, where an artist asks for support, promotes ticket sales, advertises new merchandise, and/or the like. The consumer may click on the link or scan the QR code, which may lead them to the content distribution service website and/or application. The consumer may create a content distributions service account, logging in via an appropriate interface (e.g., a single-sign-on interface).

When creating an account, the consumer may be provided with a profiling questionnaire, asking them, for example and without limitation, one or more of:
What music genres do they listen to?
Who are their favorite artists?
Are they themselves musicians, if yes what do they play?
Do they intend to upload music onto the content distribution system?

The consumer may have access to a CMC. Available interfaces in the CMC for the consumer may include, for example and without limitation, one or more of the following:
Asset Marketplace: An asset marketplace interface may be generated based on responses to the profiling questions, potentially aided with artificial intelligence methods that may profile a user relatively efficiently. Via this interface, catalogues and content assets available for purchase, rent, and/or the like may be displayed. An option to “Support” a particular artist may be available through a subscription fee and/or a credit system. An asset marketplace interface may include an “explore” tab where new offers and/or releases of content are made available. A consumer can choose using this interface to preview and/or add songs to playlists without monetary commitment.
Playlists Interface: A playlists interface may display customizable playlists from collected content. This interface may further include a media player, which may be interactive and/or customizable. In some embodiments, a user may have the option to play and/or stream certain “free” content assets (where in some implementations users are not charged for accessing the content but artists and/or creators still receive some type of remuneration). Paid content assets through subscription may also be included in playlists.
Asset Tracking: Consistent with embodiments disclosed herein, consumers may purchase fractional shares of a content asset. An asset tracking interface may provide an exchange-like interface displaying the value of any fractional shares purchased by a consumer.
Ticketing Interface: A ticketing interface may allow consumers to view upcoming live events near them and/or from artists they may follow. In some embodiments, live recordings of events and/or merchandise from artists may be made available to users.

Users can preview, download, add to playlists, and/or the like, assets of their choosing. In some implementations, if they do not pay for an asset, then a non-encrypted “preview” asset may be streamed. If they pay for the asset, they can listen to the “actual” asset, managed by the blockchain.

### Content Management Processes

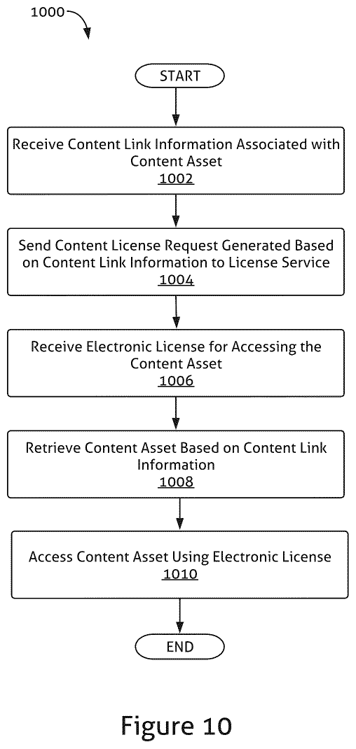

FIG. 10 illustrates a flow chart of a non-limiting example of content management process 1000 consistent with certain embodiments disclosed herein. The illustrated process 1000 may be implemented in a variety of ways, including using software, firmware, hardware, and/or any combination thereof. In certain embodiments, various aspects of the process 1000 and/or its constituent steps may be performed by a service, system, and/or device configured to implement embodiments of a consumer device, a rights license service, a trusted ledger service, a content distribution service, and/or any other suitable application, device, system and/or service or combination of applications, devices, systems, and/or services.

At 1002, content link information associated with a content asset may be received by a user device. For example, as detailed herein, content link information may be distributed by artists, creators, and/or rightsholders to prospective consumers. The content link information may be received by the user device when accessing a web page, a social media service, email or other electronic correspondence, and/or by capturing the information using a device sensor such as, for example and without limitation, a camera. Content link information may be generated by a variety of rightsholders including, for example and without limitation, an original creator of the content asset. In further embodiments, content link information may be generated by a rightsholder whose rights were derived from another rightsholder in the content asset.

The content link information may comprise a variety of information including license information. The license information may include content agreement information and license service access information. In some embodiments, the content agreement information may comprise a location and/or other access information of one or more structured representation(s) of agreements included in an agreement repository. The license information may, in some embodiments, identify a license service for retrieving licenses to access the content asset.

The content link information may further comprise trusted ledger information referencing at least one entry in a trusted ledger. The trusted ledger may comprise cryptographically linked entries and, in some embodiments, may comprise a trusted immutable distributed assertion ledger and/or a blockchain ledger.

In some embodiments, the content link information may comprise content distribution information. The content distribution information may comprise location information for accessing the content asset.

In further embodiments, the content link information may comprise content payment information that may include remuneration information associated with accessing the content asset and payment gateway identification information. Consistent with embodiments disclosed herein, in some embodiments, the user device may engage in at least one transaction with a payment gateway service identified by the payment gateway identification information based on the content payment information.

A content license request may be sent by the user device to the license service identified in the license information at 1004. In some embodiments, the content license request may be generated based on the license information and the trusted ledger information included in the content link information.

At 1006, an electronic license for accessing the content asset may be received from the license service. The electronic license may be generated by the license service based, at least in part on the content agreement information. For example, some embodiments, the electronic license may be generated based on agreement terms associated with the content asset retrieved by the license service based on the content agreement information included in the content link information. Agreement terms may be retrieved, for example and without limitation, from an agreement repository, from the trusted ledger, and/or the like. In certain embodiments, the electronic license may be further generated based on the license service successfully validating a secure cryptographic association between the content agreement information and the content asset recorded in the trusted ledger.

The content asset may be retrieved by the user device based on the content distribution information included in the content link information at 1008. At 1010, the content asset may be accessed by the user device using the electronic license (e.g., using a decryption key included in the license to decrypt the content asset). In some embodiments, accessing the content asset may comprise downloading the asset for rendering on the user device and/or initiating a stream of the content asset on the user device.

System and/or Service Architecture

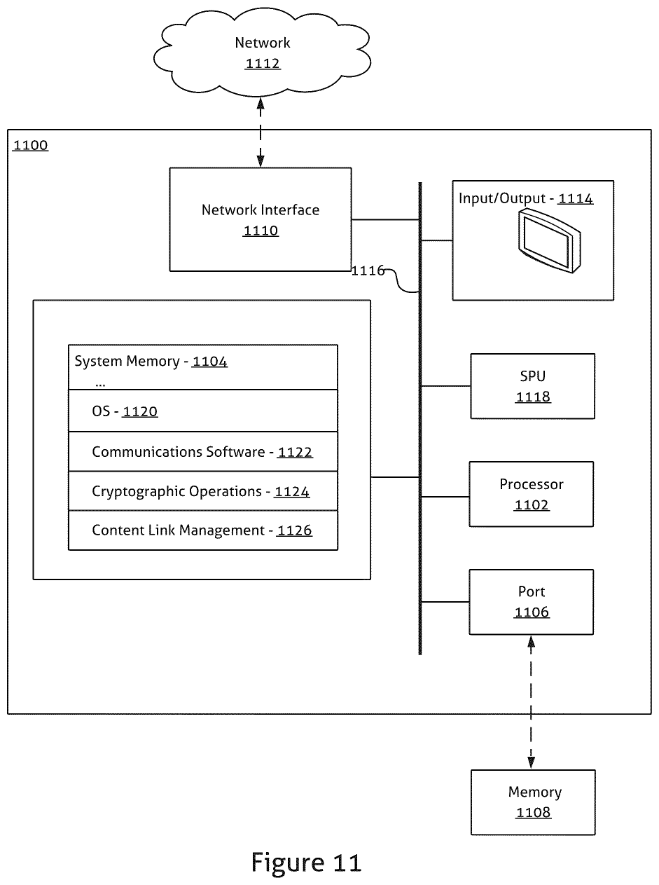

FIG. 11 illustrates a non-limiting example of a system 1100 that may be used to implement certain embodiments of the systems and methods of the present disclosure. The system 1100 of FIG. 11 and/or aspects thereof may be included in a system, service, and/or device associated with any of the systems, devices, services, and/or entities described herein (and/or combinations of the same), and/or any other service, which may comprise a trusted service, system, and/or component configured to implement embodiments of the disclosed systems and methods and/or aspects thereof.

The various systems and/or devices used in connection with aspects the disclosed embodiments may be communicatively coupled using a variety of networks and/or network connections (e.g., network 1112). In certain embodiments, the network 1112 may comprise a variety of network communication devices and/or channels and may utilize any suitable communications protocols and/or standards facilitating communication between the systems and/or devices. The network 1112 may comprise the Internet, a local area network, a virtual private network, and/or any other communication network utilizing one or more electronic communication technologies and/or standards (e.g., Ethernet or the like). In some embodiments, the network 1112 may comprise a wireless carrier system such as a personal communications system (“PCS”), and/or any other suitable communication system incorporating any suitable communication standards and/or protocols. In further embodiments, the network 1112 may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network 1112 may incorporate one or more satellite communication links. In yet further embodiments, the network 1112 may utilize IEEE's 802.11 standards, Bluetooth®, ultra-wide band (“UWB”), Zigbee®, and or any other suitable standard or standards.

The various systems and/or devices used in connection with aspects of the disclosed embodiments may comprise a variety of computing devices and/or systems, including any computing system or systems suitable to implement the systems and methods disclosed herein. For example, the connected devices and/or systems may comprise a variety of computing devices and systems, including laptop computer systems, desktop computer systems, server computer systems, distributed computer systems, smartphones, tablet computers, and/or the like.

In certain embodiments, the systems and/or devices may comprise at least one processor system configured to execute instructions stored on an associated non-transitory computer-readable storage medium. As discussed in more detail below, systems used in connection with implementing various aspects of the disclosed embodiments may further comprise a secure processing unit (“SPU”) configured to perform sensitive operations such as trusted credential and/or key management, cryptographic operations, secure policy management, and/or other aspects of the systems and methods disclosed herein. The systems and/or devices may further comprise software and/or hardware configured to enable electronic communication of information between the devices and/or systems via a network using any suitable communication technology and/or standard.

As illustrated in FIG. 11, the example system 1100 may comprise: a processing unit 1102; system memory 1104, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 1102; a port 1106 for interfacing with removable memory 1108 that may include one or more diskettes, optical storage mediums (e.g., flash memory, thumb drives, USB dongles, compact discs, DVDs, etc.) and/or other non-transitory computer-readable storage mediums; a network interface 1110 for communicating with other systems via one or more network connections and/or networks 1112 using one or more communication technologies; a user interface 1114 that may include a display and/or one or more input/output devices such as, for example, a touchscreen, a keyboard, a mouse, a track pad, and the like; and one or more busses 1116 for communicatively coupling the elements of the system.

In some embodiments, the system 1100 may, alternatively or in addition, include a trusted execution environment and/or an SPU 1118 that is protected from tampering by a user of the system or other entities by utilizing secure physical and/or virtual security techniques. A trusted execution environment and/or a SPU 1118 can help enhance the security of sensitive operations such as personal information management, trusted credential, token, and/or key management, privacy and policy management, and other aspects of the systems and methods disclosed herein. In certain embodiments, the trusted execution environment and/or SPU 1118 may operate in a logically secure processing domain and be configured to protect and operate on secret information, as described herein. In some embodiments, the trusted execution environment and/or a SPU 1118 may include internal memory storing executable instructions or programs configured to enable the SPU 1118 to perform secure operations, as described herein.

The operation of the system 1100 may be generally controlled by the processing unit 1102 and/or an SPU 1118 operating by executing software instructions and programs stored in the system memory 1104 (and/or other computer-readable media, such as memory 1108, which may be removable). The system memory 1104 may store a variety of executable programs or modules for controlling the operation of the system. For example, the system memory may include an operating system (“OS”) 1120 that may manage and coordinate, at least in part, and/or system hardware resources and provide for common services for execution of various applications.

The system memory 1104 may further include, without limitation, communication software 1122 configured to enable in part communication with and by the system, one or more applications, a cryptographic operation module 1124 configured to perform various aspects of the disclosed embodiments, content information link management module 1126 configured to perform various aspects of the methods disclosed herein, and/or any other information, modules, and/or applications configured to implement embodiments of the systems and methods disclosed herein.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. For example, it will be appreciated that a number of variations can be made to the various embodiments, systems, services, and/or components presented in connection with the figures and/or associated description within the scope of the inventive body of work, and that the examples presented in the figures and described herein are provided for purposes of illustration and explanation, and not limitation. It is further noted that there are many alternative ways of implementing both the systems and methods described herein. Accordingly, the present embodiments are to be considered as illustrative and not restrictive, and the embodiments of the invention are not to be limited to the details given herein but may be modified within the scope and equivalents of the appended claims.

1. A method for accessing a content asset by a user device comprising a processor and a non-transitory computer-readable storage medium storing instructions that, when executed by the processor, cause the user device to perform the method, the method comprising:
receiving, by the user device, content link information associated with the content asset, the content link information comprising:
license information, the license information comprising content agreement information and license service access information,
trusted ledger information referencing at least one entry in a trusted ledger, and
content distribution information, the content distribution information comprising location information for accessing the content asset;
sending, by the user device to a license service, a content license request, the content license request being generated based on the license information and the trusted ledger information included in the content link information; and
receiving, by the user device from the license service, an electronic license for accessing the content asset, the electronic license being generated by the license service based on the content agreement information;
retrieving the content asset by the user device based on the content distribution information included in the content link information; and
accessing the content asset using the electronic license.

2. The method of claim 1, wherein the content link information is received from one or more of a website accessed by the user device, a social media service, and an electronic communication.

3. The method of claim 1, wherein receiving the content link information comprises capturing the content link information using a sensor of the user device.

4. The method of claim 3, wherein the sensor of the user device comprises a camera sensor.

5. The method of claim 1, wherein the content link information further comprises content payment information, the content payment information comprising remuneration information associated with accessing the content asset and payment gateway identification information.

6. The method of claim 5, wherein the method further comprises engaging in at least one transaction with a payment gateway service identified by the payment gateway identification information based on the content payment information.

7. The method of claim 1, wherein the license service is identified in license information included in the content link information.

8. The method of claim 1, wherein the content link information is generated by a rightsholder associated with the content asset.

9. The method of claim 8, wherein the rightsholder comprises a creator of the content asset.

10. The method of claim 1, wherein the content agreement information comprises a location of one or more structured representations of agreements included in an agreement repository.

11. The method of claim 1, wherein the electronic license comprises at least one content decryption key.

12. The method of claim 11, wherein accessing the content asset comprises decrypting at least a portion of the content asset using the at least one content decryption key.

13. The method of claim 1, wherein accessing the content asset comprises at least one of downloading the content asset and initiating a rendering stream of the content asset.

14. The method of claim 1, wherein the electronic license is generated based on agreement terms associated with the content asset retrieved by the license service based on the content agreement information included in the content link information.

15. The method of claim 14, wherein the agreement terms are retrieved from an agreement repository.

16. The method of claim 14, wherein the agreement terms are retrieved from the trusted ledger.

17. The method of claim 1, wherein the electronic license is further generated based on validating a secure cryptographic association between the content agreement information and the content asset recorded in the trusted ledger.

18. The method of claim 1, wherein the trusted ledger comprises cryptographically linked entries.

19. The method of claim 18, wherein the trusted ledger comprises a trusted immutable distributed assertion ledger.

20. The method of claim 19, wherein the trusted immutable distributed assertion ledger comprises a blockchain ledger.
